(19) United States
(12) Patent Application Publication
(10) Pub. No.: US 2025/0332605 A1
(43) Pub. Date: Oct. 30, 2025

(54) APPARATUS AND METHOD FOR GENERATING FINE DROPLETS AND LIQUID PARTICLE COUNTING SYSTEM INCLUDING THE SAME

(71) Applicant: MINDSEYE CO., LTD., Gyeonggi-do (KR)

(72) Inventor: Ji Joong HONG, Seoul (KR)

(21) Appl. No.: 19/071,748

(22) Filed: Mar. 5, 2025

(30) Foreign Application Priority Data
Apr. 30, 2024 (KR) 10-2024-0057463

(51) Int. Cl. B05B 12/08; B05B 5/035; B05B 5/053; B05B 12/00

(52) U.S. Cl. CPC B05B 12/082; B05B 5/035; B05B 5/0533; B05B 12/006

(57) ABSTRACT

An electrospray device for aerosolizing a conductive liquid includes: a liquid delivery drive unit by which the conductive liquid is introduced into an emitter; an emitter that discharges the conductive liquid introduced into the emitter through an emitter tip to aerosolize the conductive liquid; a counter electrode disposed to face the emitter tip; a sheath flow guide part disposed around the emitter to provide a sheath flow; an electrode part that applies a voltage to form a potential difference between the emitter or the conductive liquid and the counter electrode; and a camera that captures an image of a liquid cone on the emitter tip, wherein an electric force acts on the conductive liquid on the emitter tip by the voltage applied from the electric electrode part, causing droplets to be discharged from the emitter tip toward the counter electrode to generate an aerosol.

### CROSS-REFERENCE TO RELATED APPLICATION

This application claims priority to and the benefit of Korean Patent Application No. 2024-0057463, filed on Apr. 30, 2024, the disclosure of which is incorporated herein by reference in its entirety.

### BACKGROUND

### 1. Field of the Invention

The present invention relates to an apparatus and method for generating fine droplets, and more specifically, to an electrospray device capable of automatically controlling the generation of fine droplets, an automated control method of the device, and an aerosol-based liquid particle counting system including the device.

### 2. Discussion of Related Art

Various liquids used in industries that require sterilization, clean production, and cleanroom environments, such as semiconductor, pharmaceuticals, biotechnology, and microelectronics, must be maintained at an appropriate level of purity. To ensure this, various measurement devices, including liquid particle counters, have been used to monitor and control impurities or fine particles present in cleaning and reaction solutions.

Recently, in the semiconductor industry, with the advancement of semiconductor fabrication technology to the line width 5 nm, it has become necessary to control fine impurity particles as small as 30 nm. Furthermore, in addition to particle size, there is also a demand in the field to maintain a high level of liquid purity, specifically at a level of 10³ particles per cubic centimeter (particles/cc).

An aerosol-based particle counting system is intended to detect impurities such as particles in a liquid by overcoming the measurement limitations of conventional liquid particle counters. An aerosol-based particle counting technology is a technology that aerosolizes a liquid (a solution containing fine particles, etc.), and measures the aerosol or measures particles in the liquid through various processes. The aerosol-based particle counting system may include, for example, an aerosolizer, a dryer, a differential mobility analyzer (DMA), and a condensation particle counter (CPC). Droplets from the aerosolizer are dried and classified, and the classified particles are detected by a condensation particle counter (CPC). Such systems are disclosed in U.S. Pat. Nos. 4,761,074, 5,098,657, and 7,777,868. This aerosol-based particle counting system provides improved detection sensitivity and extends the particle size detection limit to below 5 nm.

Methods for aerosolizing a sample liquid include ultrasonic aerosolization, pneumatic aerosolization, frit and thermo-spray methods, and electrospray. Among these, electrospray devices offer the advantage of forming smaller droplets compared to pneumatic aerosolization devices, allowing for the formation of droplets as small as 50 nm.

As shown in FIG. 1, an electrospray device pressurizes a conductive liquid 16 to transport the conductive liquid 16 through a capillary 12, and the capillary (or conductive liquid) is connected to a power supply to apply a high voltage. A ground portion 26 is disposed at a position facing the capillary tip, and an electric force acts due to the potential difference between the ground portion 26 and a conductive liquid cone 20 at the capillary tip to which a high voltage is applied. In the electrospraying process, when an electric force greater than the surface tension of the conductive solution on the capillary tip is applied, the conductive solution cone discharged is formed as a liquid cone 20 at the nozzle tip, and the liquid cone stretches in the longitudinal direction toward the ground portion 26 to form a jet stream 22, thereby generating a droplet spray 24.

Conventionally, a skilled person in the related art directly checked the electrospray process and finely adjusted the control parameters related to the formation of the cone jet, such as the flow rate (or hydraulic pressure) of the liquid supplied into the capillary and the applied high voltage, to generate an aerosol. However, this laboratory-level manual control method is not suitable for application to a particle counting system for liquid monitoring in a production process. Additionally, the liquid flow rate and applied voltage for aerosolization vary depending on the diameter of the capillary for the conductive liquid, the arrangement specifications of the ground portion (for example, distance from the capillary tip), and the characteristics of the liquid (for example, viscosity, relative permittivity, surface tension, conductivity). However, an automated electrospray device capable of efficiently producing an aerosol under various conditions and a control method thereof have not been provided.
(Patent Document 1) KR 10-2016-0096607 A

### SUMMARY OF THE INVENTION

The present invention is directed to providing an automatically controllable electrospray device.

The present invention is also directed to providing an automated electrospray device capable of stably generating an aerosol under various liquid and environmental conditions and an automated aerosol generation method.

The present invention is also directed to providing an aerosol-based liquid particle counter including an automated electrospray device, which can be applied in real time in a production process and eliminate measurement errors caused by non-volatile residue (NVR) in sample solutions, thereby providing a highly accurate particle counting system.

According to an aspect of the present invention, there is provided an electrospray device for aerosolizing a conductive liquid, which includes: a liquid delivery drive unit by which the conductive liquid is introduced into an emitter; an emitter that discharges the conductive liquid introduced into the emitter through an emitter tip to aerosolize the conductive liquid; a counter electrode disposed to face the emitter tip; a sheath flow guide part disposed around the emitter to provide a sheath flow; an electrode part that applies a voltage to form a potential difference between the emitter or the conductive liquid and the counter electrode; and a camera that captures an image of a liquid cone on the emitter tip, wherein an electric force acts on the conductive liquid on the emitter tip by the voltage applied from the electric electrode part, causing droplets to be discharged from the emitter tip toward the counter electrode to generate an aerosol.

Control parameters related to aerosol generation are automatically generated based on a shape of the liquid cone on the emitter tip captured by the camera, and the aerosol generation may be automatically controlled using the control parameters.

The control parameters may include at least one of the voltage and a flow rate of the conductive liquid supplied to the emitter. Alternatively, the control parameters may be at least one of an applied voltage and a driving value of the liquid delivery drive unit. The control parameters may be a parameter related to a supply flow rate of the conductive liquid to the emitter by the liquid delivery drive unit, for example, a differential pressure between the liquid chamber and the aerosolization chamber.

A lighting unit may be disposed at a position facing the camera with the emitter tip interposed therebetween, and the camera may capture image of the liquid cone on the emitter tip.

The electrospray device may further comprise a liquid supply tube connected to one side of a chamber housing to supply the conductive liquid to the emitter; and a flowmeter that measures a flow rate of the conductive liquid supplied through the liquid supply tube,

The liquid delivery drive unit is a regulator that controls the flow rate of the conductive liquid using a measurement value measured by the flowmeter.

The electrospray device may further comprise a control unit that automatically generates the control parameters for generating an aerosol and controls the electrospray device. The control unit is included in the electrospray device or is an external information processing device connected to the electrospray device by communication.

The control unit processes a liquid cone image of the liquid cone on the emitter tip captured by the camera, compares the liquid cone image with a reference image, and adjusts the control parameters according to a comparison result.

According to another aspect of the present invention, there is provided an electrospray device comprising: a liquid chamber that accommodates a sample liquid having electrical conductivity; an aerosolization chamber connected to the liquid chamber to receive the sample liquid from the liquid chamber and aerosolize the sample liquid; and a liquid delivery drive unit that moves the sample liquid in the liquid chamber to the aerosolization chamber.

The aerosolization chamber comprises: an emitter that discharges the sample liquid introduced from the liquid chamber through an emitter tip and aerosolizes the sample liquid; a counter electrode disposed to face the emitter tip; a sheath flow guide part disposed around the emitter to provide a sheath flow; a power supply that applies a voltage to form a potential difference between the emitter or the sample liquid and the counter electrode; and a camera that captures an image of a liquid cone on the emitter tip.

An electric force acts on the liquid cone on the emitter tip by the applied voltage, causes droplets to be discharged from the emitter tip toward the counter electrode to generate an aerosol.

The electrospray device may further comprise: a differential gauge that measures a pressure difference between the liquid chamber and the aerosolization chamber; and a control unit connected to the power supply, the differential gauge, the camera, and the liquid delivery drive unit.

The control unit generates control parameters for automatically adjusting the voltage and the pressure difference based on an image of the liquid cone on the emitter chip captured by the camera.

The liquid delivery drive unit is a differential regulator connected to the liquid chamber to generate a pressure difference between the liquid chamber and the aerosolization chamber. The differential regulator and the power supply are automatically controlled using control parameters.

According to the other aspect of the present invention, an aerosol-based liquid particle counting system is provided. The aerosol-based liquid particle counting system may include the electrospray device; a dryer that dries the aerosol discharged from the electrospray device; a particle classification device connected to the dryer; and a condensation particle counter connected to the particle classification device.

In addition, an automated control method of the electrospray device may be provided. The method comprising: obtaining a liquid cone image by operating the electrospray device to generate a liquid cone on the emitter tip and capturing an image of the liquid cone on the emitter tip in real time; processing the liquid cone image; and adjusting control parameters.

The automated control method of the electrospray device may further comprise generating a recipe before the obtaining of the liquid cone image. The recipe includes a reference image or reference geometric parameters according to a type of the conductive liquid.

According to the automated control method, before the adjusting of the parameters, the liquid cone image is compared with the reference image in the recipe to determine whether to adjust the control parameters, and the reference image is an image of the liquid cone on the emitter tip captured when optimal aerosolization is achieved.

The automated control method may further comprise, before the obtaining of the liquid cone image, generating a recipe. The recipe is preferrable to includes a reference image and a reference cone horizontal length, the reference image is an image of the liquid cone on the emitter tip captured when optimal aerosolization is achieved, and the reference cone horizontal length is a horizontal length of only the cone on the emitter tip in the reference image,

The processing of the liquid cone image comprises: obtaining a difference image between the liquid cone image and the reference image; calculating a difference in the cone horizontal length between the liquid cone image and the reference image; calculating an area of the difference image; determining whether both the area of the difference image and the length difference are within allowable values; and maintaining the control parameters when the area and the difference are within the allowable values according to the determination, and adjusting the control parameters when the area and the difference are outside the allowable values.

The difference in the cone horizontal length is a difference between the reference cone horizontal length and the cone horizontal length in the liquid cone image.

The automated control method may further comprise: before the obtaining of the liquid cone image while generating the liquid cone, capturing an initial emitter image including the emitter tip in a state in which the liquid cone is not generated; and calculating parameters from the initial emitter image and storing the reference parameters.

The processing of the liquid cone image comprises: performing preprocessing on the liquid cone image; obtaining a cone image by subtracting the initial emitter image from the liquid cone image; processing the cone image to calculate one or more geometric parameters; comparing the geometric parameters with the reference parameters; generating control parameters based on the comparison; and adjusting at least one of the voltage, a flow rate of a supply tube, and a driving value of the liquid delivery drive unit based on the control parameters.

The recipe may include one or more of a reference image and a reference geometric parameter. The recipe may include a control parameter based on at least one of a difference between the reference image and a cone image and a difference between the reference geometric parameter and a geometric parameter of the cone image.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram for describing the structure of an electrospray device;

FIG. 2 is a schematic diagram showing the fluid and electrical circuit of the electrospray device;

FIG. 3 is a partial cross-sectional view of an electrospray device according to an embodiment of the present invention;

FIG. 4 is a partial perspective view of an electrospray device according to an embodiment of the present invention;

FIG. 5 is a right side view of the electrospray device of FIG. 4;

FIG. 6 is a diagram showing a liquid chamber of an electrospray device according to an embodiment of the present invention;

FIG. 7 is a schematic diagram showing the generation of an aerosol in an electrospray device;

FIG. 8 is a flowchart of a method of controlling aerosol generation using an electrospray device according to one embodiment of the present invention;

FIG. 9 is a schematic diagram showing the image used in FIG. 8;

FIG. 10 is an initial emitter tip image captured in a state where a liquid cone is not formed on a capillary-shaped emitter tip;

FIGS. 11 to 14 are diagrams showing a captured emitter tip image, a difference image from a reference image, and cone geometric parameters according to another embodiment of the present invention;

FIG. 15 is a block diagram showing a simplified configuration of an aerosol-based liquid particle counting system including the electrospray device of the present invention; and

FIGS. 16 and 17 are drawings sequentially showing the results of aerosolizing a sample liquid using an electrospray device according to one embodiment of the present invention and measuring the liquid particle count using an aerosol-based liquid particle counting system.

### DETAILED DESCRIPTION OF EXEMPLARY EMBODIMENTS

Hereinafter, embodiments of the present invention will be described in detail with reference to the accompanying drawings so that those skilled in the art can easily implement the invention. However, the present invention may be embodied in many different forms and is not limited to the embodiments described herein. For clarity, parts irrelevant to the description are omitted in the drawings, and similar reference numerals are assigned to similar parts throughout the specification. In this process, the thickness of lines or the size of components in the drawings may be exaggerated for clarity and convenience.

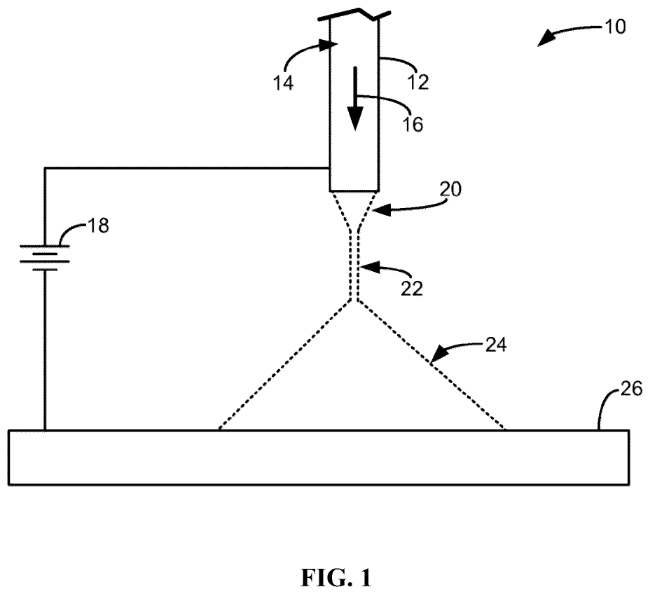

In an electrospray device such as that illustrated in FIG. 1, in order to generate an aerosol of fine droplets from a liquid supplied to an emitter (usually a glass or metal capillary), the flow rate (or the pumping pressure or regulator pressure difference for supplying the liquid through a supply tube) and the voltage applied to the emitter must be adjusted to form a Taylor cone at the emitter tip.

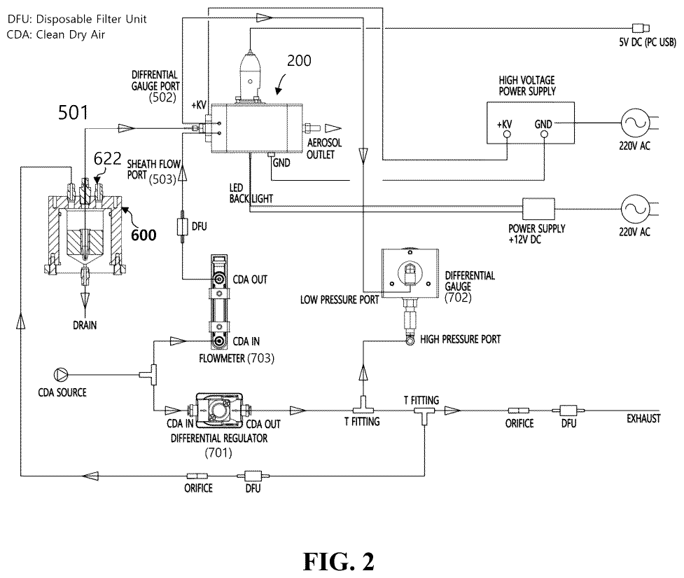

An electrospray device according to one embodiment of the present invention and a fluid and electrical circuit system including the same will be first described with reference to FIG. 2

Referring to FIG. 2, an electrospray device according to one embodiment of the present invention includes a liquid chamber 600 that accommodates a sample liquid, an aerosolization chamber 200 connected to the liquid chamber 600 to receive and aerosolize the sample liquid, and a differential regulator 701 connected to the liquid chamber 600 to provide air pressure to move the sample liquid in the liquid chamber 600 to the aerosolization chamber.

The upstream side of the regulator 701 is connected to an air source (a clean dry air (CDA) source) that provides CDA, and the downstream side of the regulator 701 is connected to an air inlet port 623 of the liquid chamber 600. When high-pressure air is introduced into the liquid chamber by the regulator, the sample liquid is supplied to the aerosolization chamber 200 through a liquid supply tube 501 by utilizing the pressure difference inside the liquid chamber 600 with respect to the aerosolization chamber. The liquid supply tube 501 may be a capillary, and one end of the liquid supply tube is connected to the sample liquid contained in a vial seated in a mounting portion inside the airtight liquid chamber 600, and the other end is connected to the aerosolization chamber. The regulator 701 acts as a liquid delivery drive unit, and although this method using air pressure is effective, the liquid delivery drive unit is not limited thereto. Instead of the vial, the sample liquid may be directly contained in the liquid chamber.

A differential gauge 702 is connected to the aerosolization chamber 200 and the liquid chamber 600 to measure a pressure difference between the two chambers. A high pressure port of the differential gauge 702 is connected to a downstream flow path of the regulator 701 connected to the liquid chamber 600, and a low pressure port of the differential gauge 702 is connected to the aerosolization chamber 200 to measure a pressure difference between the aerosolization chamber 200 and the liquid chamber 600. Specifically, the high pressure port of the differential gauge 702 is connected to a flow path connecting the regulator 701 and the liquid chamber 600 by a T-joint, and the low pressure port is connected to a differential gauge port 502 formed in an airtight housing of the aerosolization chamber 200.

The flow rate of the sample liquid supplied to the aerosolization chamber can be controlled by controlling the regulator 701 based on the measurement value measured by the differential gauge 702. The regulator can be controlled manually or automatically.

Instead of the differential gauge 702, a flowmeter (not shown) that directly measures the flow rate of the conductive liquid supplied through the liquid supply tube 501 may be included in the middle of the liquid supply tube 501, and the regulator 701 may be controlled based on the measurement value measured by the flowmeter. Alternatively, a flowmeter that directly measures the flow rate of the conductive liquid supplied through the liquid supply tube 501 and a liquid flow control regulator (not shown) may be included in the middle of the liquid supply tube 501 to control the flow rate of the liquid supplied to the emitter. In this case, the flow rate of the liquid supplied to the emitter is controlled by the liquid flow control regulator (not shown) instead of the regulator 701.

According to an embodiment of the present invention, the regulator can be automatically controlled by a control unit (not shown) included as part of the aerosolization device or connected externally. The control unit is an information processing device, including a processor and a memory. The processor may be a signal processing processor such as a central processing unit (CPU), a graphics processing unit (GPU), an image signal processor (ISP), a digital signal processor (DSP), or a field programmable gate array (FPGA), and the memory may include a volatile or nonvolatile memory or a solid state drive (SSD), and can execute various tasks by a combination of SW programs and/or hardware.

The flow path from the CDA source branches into two branches. One is connected to the regulator 701 to provide pressurized air for moving the sample liquid, and the other is connected to a sheath flow port 503 of the aerosolization chamber 200 through a sheath flowmeter 703 to provide sheath air through a sheath flow guide part 252 of the aerosolization chamber 200.

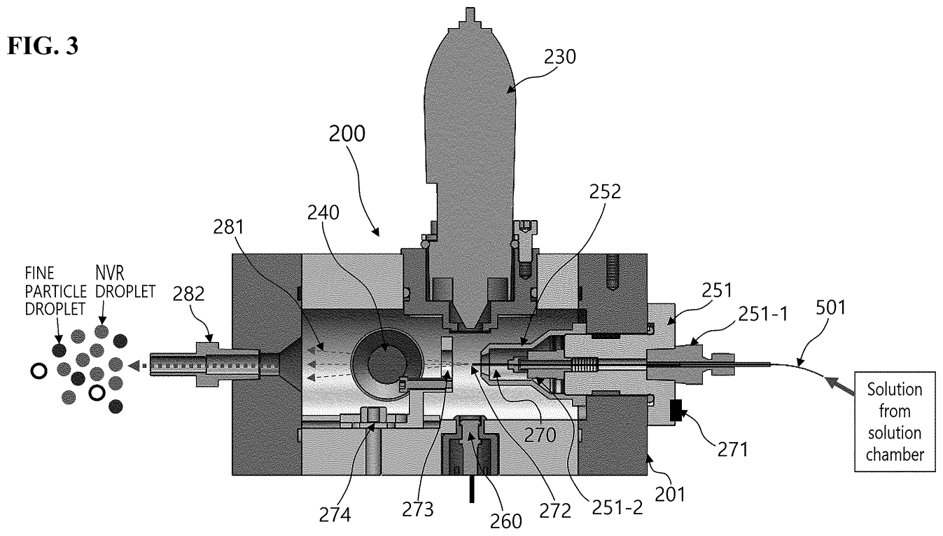

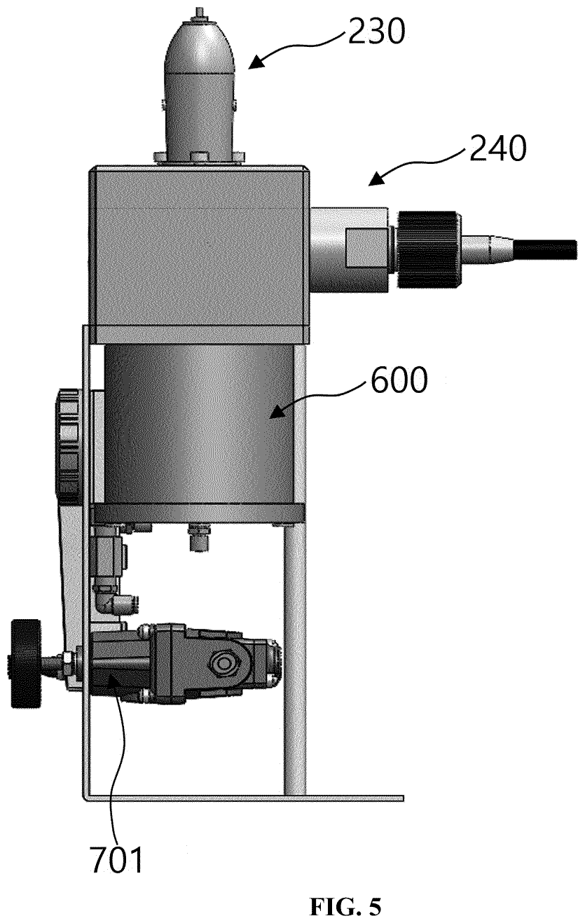

An electrospray device according to one embodiment of the present invention will be described in detail with reference to FIGS. 3 to 5.

An electrospray device according to one embodiment of the present invention includes a ⊏-shaped frame 801, the aerosolization chamber 200 mounted on the upper end of the frame, the liquid chamber 600 mounted on the bottom surface of the upper end of the frame, the differential gauge 702 connected between the aerosolization chamber 200 and the liquid chamber 600 to measure a pressure difference, and the regulator 701 that controls air pressure inside the liquid chamber 600.

The aerosolization chamber 200 of the electrospray device according to one embodiment of the present invention includes an emitter that discharges and aerosolizes an introduced liquid through an emitter tip 272, a ground ring 273 that is a counter electrode disposed to face the emitter tip, a sheath flow guide part 252 disposed around the emitter to provide a sheath flow, the emitter tip, a chamber housing 201 that holds the emitter tip, the counter electrode, and a camera unit 230 for capturing an image of the emitter tip and a liquid cone on the emitter tip.

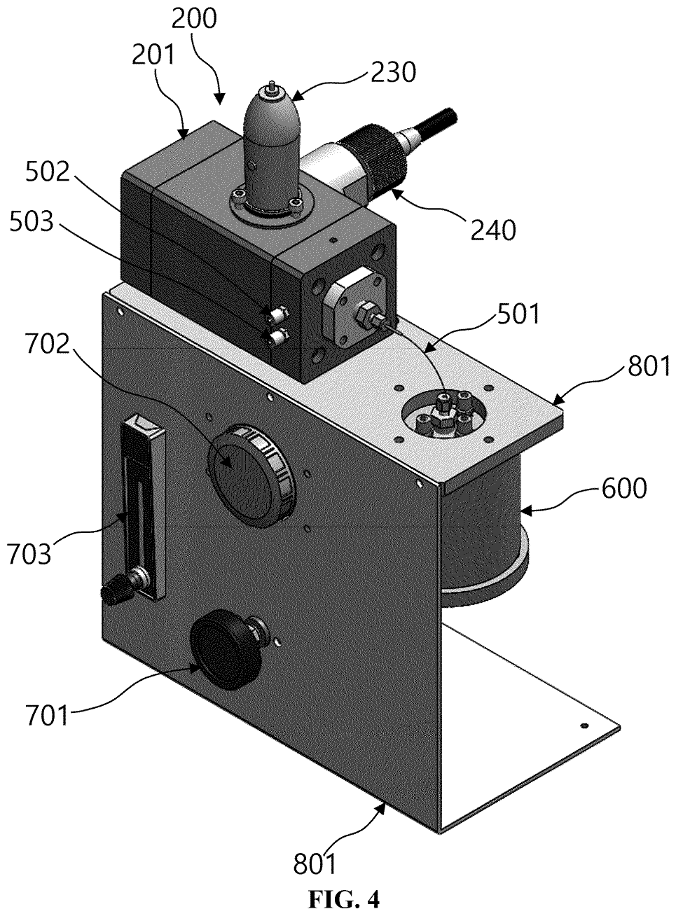

The chamber housing 201 has a quadrangular cylinder shape but is not limited thereto. Referring to FIGS. 3 and 4, a capillary mount fitting part 251 is hermetically coupled to a supply tube 501 on one side of the chamber housing 201, and an aerosol outlet port 282 for discharging an aerosol generated inside to the outside is formed on the other side. A tube or other measuring device can be connected to the aerosol outlet port 282.

The liquid supply tube 501 is a capillary, and one end of the capillary 501 is connected to the liquid chamber, and the other end is inserted into a fitting member 251-1 and introduced into the chamber housing 201 through the capillary mount fitting part 251. The other end of the capillary 501 forms an emitter, and its tip forms the emitter tip 272 and is fixed to a predetermined position in the chamber by a fitting member 251-2 coupled to the capillary mount fitting part 251. The fitting members 251-1 and 251-2 are each coupled to the capillary mount fitting part 251 that is hermetically coupled to a through-hole formed on one side of the chamber housing 201, and the capillary is fitted and placed in a long hollow space formed therein. In this embodiment, as shown in FIGS. 3 and 4, a single capillary forms the supply tube 501 at one end and the emitter 270 at the other end, but the supply tube and the emitter may be configured as separate parts. Additionally, other components, such as a fluid tube, a pump, a regulator, and other voltage-applying members, may be directly or indirectly coupled between the supply tube and the emitter, and this may be arbitrarily done by those skilled in the art through various configuration methods of the electrospray device.

The capillary or emitter is made of an electrically conductive material, and a voltage can be applied to the emitter tip. The capillary mount fitting part 251 and the capillary are made of a conductive material and are electrically connected to each other. An electrode part 271 is formed on one side of the capillary mount fitting part 251, and a power supply is connected to the electrode part 271. A potential difference is generated between the emitter tip and the counter electrode 273 disposed to face the emitter tip by the voltage applied through the electrode part, and an electric field is formed between the emitter tip and the counter electrode. An electric force acts on the conductive liquid on the emitter tip by this potential difference, and droplets are discharged toward the counter electrode. Details of the aerosolization method will be described below.

However, the emitter may be a non-conductive material such as glass rather than an electrically conductive material. When the emitter is a non-conductive material, a voltage may be applied from the power supply to the conductive sample liquid itself, rather than the electrode part 271 and the emitter. In this case, the liquid cone on the emitter tip has a potential difference relative to the counter electrode 273, and an aerosol can be discharged toward the counter electrode. Since the method of applying voltage to the sample liquid rather than the emitter is also a well-known method, a description thereof will be omitted.

Meanwhile, the sheath flow guide part 252 disposed around the emitter to provide a sheath flow is provided. The sheath flow guide part is fitted to the inner end of the capillary mount fitting part 251 and is disposed in a cylindrical nozzle shape around the emitter. The sheath flow guide part 252 is connected to the sheath flow port 503 of the aerosolization chamber and receives air from the CDA source.

The emitter 270 may be a glass or conductive metal tube for discharging the sample liquid supplied through the liquid supply tube 501 through the emitter tip 272. The emitter tip 272 is a tube or nozzle having a narrow diameter with an open end and formed at the tip of the emitter.

A hollow annular counter electrode 273 is disposed at a position facing the emitter tip. The counter electrode 273 is made of a conductive material and is grounded by a ground connector 274, which is a counter electrode part connected thereto. The annular counter electrode 273 may be disposed between the aerosol outlet port 282 and the emitter tip at a predetermined distance from the emitter tip. The predetermined interval is preferably 10 mm but is not limited thereto. The hollow central axis of the annular counter electrode 273 is preferably disposed coaxially with the emitter tip. According to this arrangement, when conductive droplets are discharged from the emitter tip 272, the droplets can move toward the annular counter electrode by an electric field, pass through the hollow, and then move toward the aerosol outlet port 282.

At a position of the emitter facing the above-mentioned counter electrode 273, an X-ray unit 240 is provided to neutralize the generated aerosol. The X-ray unit 240 includes an energy source from outside the aerosolization chamber and is disposed so that a disk-shaped X-ray generator, which is part of the X-ray unit, can radiate X-rays into the chamber on the movement path of the aerosol. The X-ray unit 240 is coupled to not affect the airtightness of the aerosolization chamber.

The camera unit 230 is disposed to capture images of the emitter tip, the liquid cone on the emitter tip, and the aerosol discharged from the emitter tip. Referring to FIGS. 3 to 5, the camera unit 230 is disposed on the upper surface of the aerosolization chamber so as to face the emitter tip. The camera unit 230 is hermetically coupled to the outside of the chamber housing so as to capture images of the emitter tip through a through-hole or a light-transmitting window formed in the upper surface of the chamber housing. The camera unit 230 is disposed to capture the profile of the emitter tip and the liquid cone on the emitter tip. For example, it is preferable that the optical axis of the camera unit 230 and the extension line of the emitter are perpendicular to each other, and the emitter tip is disposed on the optical axis of the camera unit 230. It is sufficient that the camera unit 230 is disposed to capture the images of the emitter tip and its surroundings. The camera unit 230 may be coupled to a side or bottom surface other than the upper surface of the aerosolization chamber, and a small camera unit may be mounted inside the chamber housing of the aerosolization chamber.

The camera unit 230 is a general camera and includes an optical system such as an image sensor and a lens. The camera unit 230 may have a communication module for connection with an information processing device, and may include its own memory or processor, but is not limited thereto.

A lighting unit 260 is disposed at a position facing the camera unit with the emitter tip interposed therebetween. The lighting unit 260 is a backlight unit, and it is preferable that its central optical axis coincides with the optical axis of the camera unit 230. The liquid cone profile on the emitter tip is captured more clearly using the light emitted by the lighting unit.

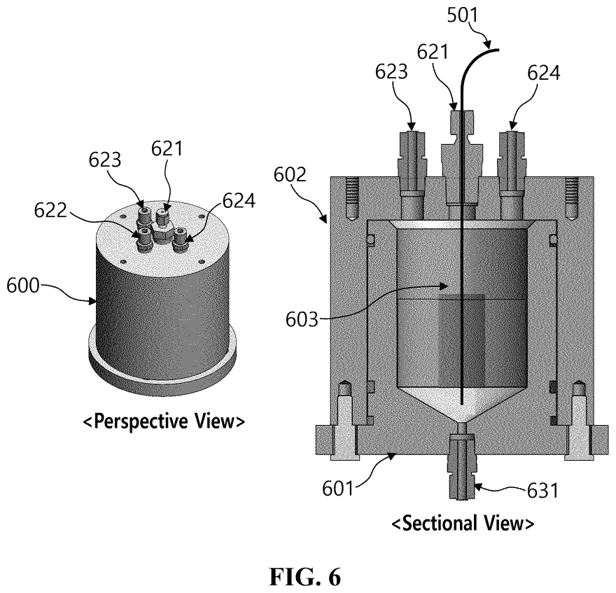

The liquid chamber 600 is described in detail with reference to FIG. 6. FIG. 6A is a perspective view of the liquid chamber, and FIG. 6B is a longitudinal sectional view of the liquid chamber. The liquid chamber 600 is an airtight container that stores a sample liquid in a storage space 603 and includes a liquid container 601 and a cover 602 that are hermetically coupled by a fastening member and an O-ring. A supply tube port 621, an air inlet port 623, and an air exhaust port 624 are formed at the upper part of the liquid chamber 600, and a drain port 631 is formed at the lower part. The supply tube port 621 is for connecting to the supply tube 501, the air inlet port 623 is a port through which high-pressure air is introduced into the liquid chamber by a regulator, and thus the sample liquid is supplied to the aerosolization chamber 200 through the liquid supply tube 501 by utilizing the difference in air pressure between the liquid chamber 600 and the aerosolization chamber. The air exhaust port 624 is a port for exhausting air in the liquid chamber, and the drain port 631 is for draining the stored sample liquid if necessary.

The liquid chamber 600 may further include a solution injection port 622 for receiving a sample liquid to be tested through an external liquid path or from another liquid storage container that is part of the production equipment.

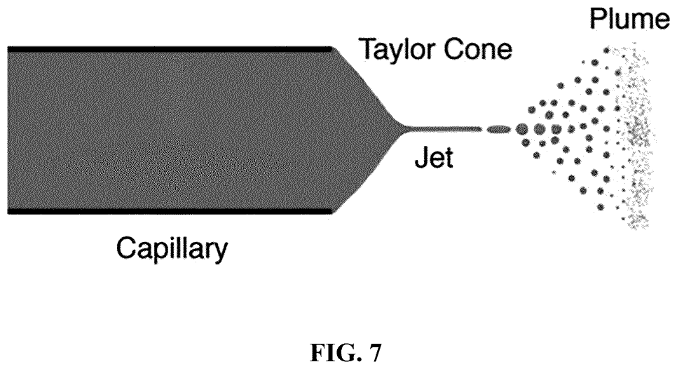

Hereinafter, an automated aerosol generation method by the electrospray device according to one embodiment of the present invention will be described in detail with reference to FIGS. 7 to 9.

FIG. 7 is a conceptual diagram for describing the process of generating an aerosol. When a small amount of electrically conductive liquid (a liquid cone on the emitter tip) protruding convexly from the emitter tip boundary by hydraulic pressure is exposed to an electric field, the shape of the liquid starts to change due to surface tension alone. As the voltage applied to the conductive liquid increases, the effect of the electric field starts to exert a force similar in magnitude to the surface tension on the liquid cone (an extension of the conductive liquid flow within the emitter, the liquid portion protruding from the emitter tip), and a conical shape with convex sides and a rounded tip starts to form. When a critical state is reached, the slightly rounded tip inverts and releases a liquid jet, which is called a cone jet, and the electrospray process of providing an aerosol in the form of a plume downstream of the cone jet starts. In the electrospray process of stable cone jetting and aerosolization, the approximate conical portion of the conical jet is called a Taylor cone, and the internal angle of the Taylor cone is approximately 98.6 degrees, which is called a Taylor angle.

The automated control method of the electrospray device according to one embodiment of the present invention includes the operations of operating the electrospray device to generate a liquid cone on the emitter tip and capturing an image of the liquid cone on the emitter tip in real time to obtain a liquid cone image; processing the liquid cone image; and adjusting control parameters using a recipe.

Here, the recipe is generated before the operations of obtaining and processing the liquid cone image in real time to adjust the control parameters. That is, the recipe is generated in advance in order to automatically generate an aerosol by the automated control of the electrospray device. In order to generate the recipe, the electrospray device is first manually controlled to set the control parameters to generate an optimal Taylor cone. The control parameters in the recipe may include the voltage applied to the electrode part when the liquid cone on the emitter tip, i.e., the cone shape, is in an optimal aerosolization state, and the flow rate of the liquid supplied to the emitter by the liquid delivery drive part. The recipe may further include a reference image, for example a Taylor cone image, which is an image of a liquid cone on the emitter tip in an optimal aerosolization state, and geometric parameters of the Taylor cone image (one or more of a cone radius, a horizontal length of the cone, and an angle formed by two upper and lower tangents of the cone).

In summary, the automated control recipe of the electrospray device according to one embodiment of the present invention includes a reference image, which is a liquid cone image on the emitter tip in an optimal aerosolization state according to the type of liquid, and reference control parameters, which are control parameters at that time. The reference control parameters are control parameters when forming a Taylor cone and may vary depending on a control element, and may include, for example, a voltage applied to the electrode part and a flow rate of the liquid supplied to the emitter by the liquid delivery drive unit. Instead of the flow rate, the reference control parameters may include a pressure difference between the aerosolization chamber and the liquid chamber for driving the liquid delivery drive unit.

The recipe may include reference geometric parameters, which are geometric parameters at that time on the emitter tip when controlling a specific sample liquid to achieve optimal aerosolization and may additionally include allowable values limiting the differences between the reference geometric parameters and the geometric parameters calculated from the liquid cone image.

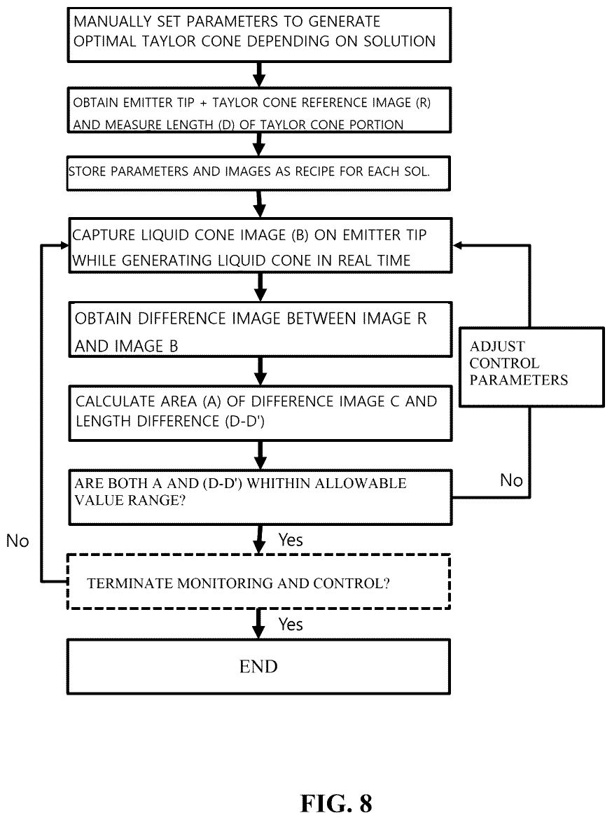

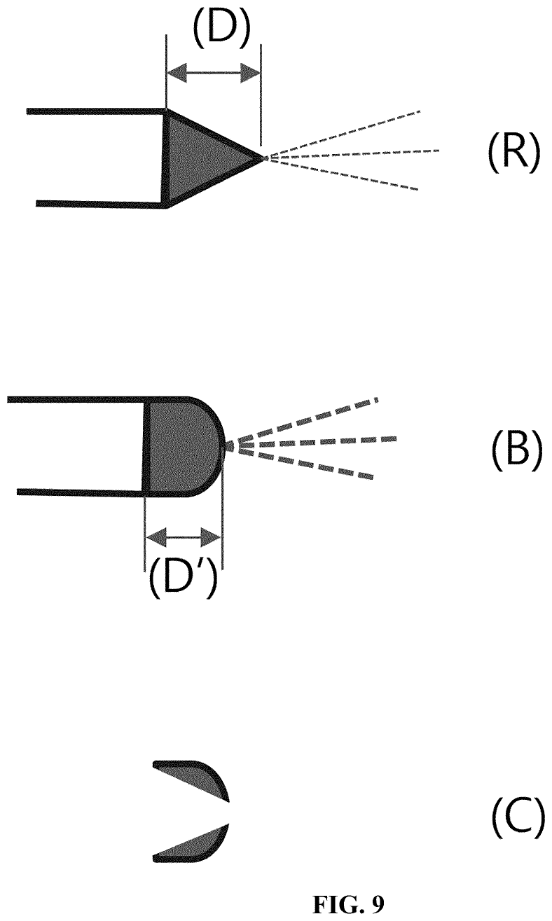

Hereinafter, an automated control method of the electrospray device according to one embodiment of the present invention will be described in detail with reference to FIGS. 8 and 9. The automated control method is performed by a control unit (information processing unit) that is communicatively connected to a camera, a differential gauge, a regulator, and a power supply (providing a voltage applied to the electrode part) and controls the camera, the regulator, and the power supply. Although there may be intervention by experts or users in some operations, unless otherwise specified, the method is performed by a software program.

The control unit is an information processing unit and may include a processor, a memory, a communication module, and a user interface (touch screen or the like) for input/output.

The automated control method of the electrospray device according to FIG. 8 can be performed by the electrospray device of the above-described embodiment but is not limited thereto.

The automated control method of FIG. 8 includes a recipe-obtaining operation, an operation of capturing an image of a liquid cone on an emitter tip while generating the liquid cone to obtain a liquid cone image; an operation of obtaining a difference image by subtracting a reference image of the recipe from the liquid cone image; an operation of calculating the area of the difference image and the difference in the horizontal length of the cone; an operation of determining whether the area of the difference image and the difference in the cone horizontal length are both within allowable values; and an operation of adjusting the control parameters based on the recipe when the result of the determination is negative and terminating the control when the result is positive. In this case, when the control parameters are adjusted, the process returns to the operation of obtaining the liquid cone image in real time again and the operation of determining whether the area of the difference image and the difference in the cone horizontal length are both within allowable values.

The recipe-obtaining operation includes an operation of supplying a liquid in the liquid chamber to the emitter while adjusting the control parameters to set the control parameters so that a Taylor cone is generated and aerosolization occurs successfully; an operation of capturing an image of the Taylor cone on the emitter tip to obtain a reference image (R) and calculating a reference horizontal length (D) of the Taylor cone from the reference image; and an operation of generating and storing a recipe including the control parameters, the reference image, and the reference horizontal length.

The control parameter setting for generating the Taylor cone may be manually adjusted by an expert but may be automatically performed using a predetermined algorithm. Even when the adjustment of the control parameters is done automatically, the final determination may be made by an expert, and the expert may input confirmation of the optimal aerosolization state through a user interface. The control unit obtains the image of the Taylor cone on the emitter tip captured by the camera as a reference image (R in FIG. 9) and measures the horizontal length of the Taylor cone portion from the reference image (R) to calculate the reference cone horizontal length (D). The control parameters, reference image (R), and reference cone horizontal length (D) in the Taylor cone generation state are stored as a recipe for each solution. In this case, the recipe may further include liquid information including the composition of the liquid.

Referring to FIG. 8, when the recipe storage operation is completed, an operation of obtaining the liquid cone image while generating the liquid cone in real time using the initial values of the control parameters is started. The initial values of the control parameters may be the initial voltage applied to the electrode part and the initial pressure difference controlled by the regulator. Instead of the initial pressure difference, the initial flow rate of the liquid supply tube may be used.

In the operation of obtaining a difference image by subtracting the reference image of the recipe from the liquid cone image, the difference image (C) is obtained by subtracting the reference image (R) from the liquid cone image (B). Since the liquid cone image (B) and the reference image (R) are captured under the same conditions, the difference image is merely the difference of only the cone portion. Although not essential, additionally, the emitter and emitter tip may be removed through preprocessing of the liquid cone image before obtaining the difference image and an image of only the cone may be obtained. In this case, the reference image may have undergone the same preprocessing in advance.

In the operation of calculating the area of the difference image and the difference in the cone horizontal length, the area of the difference image is calculated. The area of the difference image may be the number of pixels included in the difference image or the area. The horizontal length (D′) of the mere cone in the liquid cone image (B) and the horizontal length (D) of the cone in the reference image (R) is calculated, and the difference |D−D′| is calculated. The horizontal length of the cone is the horizontal distance from the emitter tip to the tip of the cone in the mere cone portion of the liquid cone image, excluding the emitter portion.

In the operation of determining whether the area of the difference image and the difference in the cone horizontal length are both within allowable values, the allowable values are determined in advance. For example, the allowable value of the area of the difference image may be within 5% or 1% of the area of the reference image (R), or 1000 pixels in absolute value. The difference in the cone horizontal length may be a positive or negative value, but the allowable value of the difference may be 5% of the horizontal length (D) of the cone of the reference image (R) or 1 mm.

As a result of the determination, when the area of the difference image and the cone horizontal length difference |D−D′| are within the allowable values, the current droplet is in the optimal form for aerosolization. In this case, when the corresponding control parameters are maintained, an aerosol will be generated properly, so the control can be terminated. Additionally, the user may be asked whether to terminate monitoring and control through a user interface, and whether to terminate may be determined based on the user's input. The process will end when the user inputs an intent to terminate, otherwise, the process proceeds to the operation of generating the liquid cone in real time again and capturing the image of the liquid cone and the subsequent operations.

Meanwhile, when the area of the difference image and the difference in the cone horizontal length |D−D′| are outside the allowable values, the control parameters are adjusted based on the recipe. For example, the control parameters are adjusted to approach the reference control parameters in the recipe.

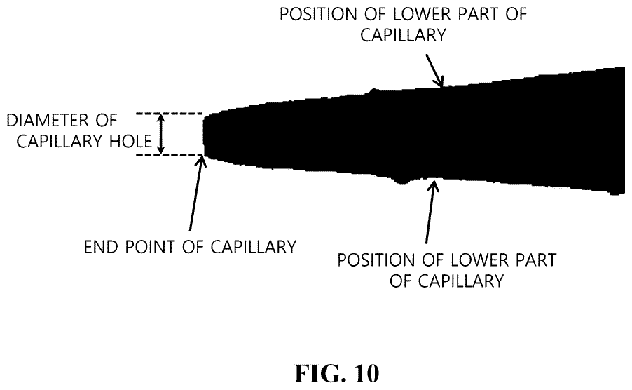

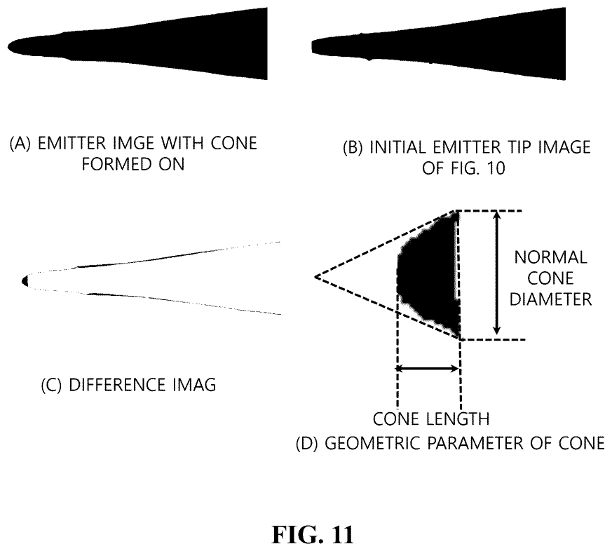

Hereinafter, a control method according to another embodiment of the present invention will be briefly described with reference to FIGS. 10 to 14. FIG. 10 shows an initial emitter tip image captured in a state in which a liquid cone is not formed on a capillary-shaped emitter tip. That is, in this state, since sufficient pressure is not applied by the liquid delivery drive unit, the liquid does not protrude from the emitter tip in the form of a liquid cone.

FIG. 11 shows an image captured in a state where a normal Taylor cone (FIG. 11A) is formed at the emitter tip and its difference image (FIG. 11C). FIG. 11C is a difference image obtained by subtracting the initial emitter tip image from the emitter tip image where the cone is formed, and FIG. 11D shows the calculated diameter and length of the cone. That is, FIG. 11D shows the calculated diameter and length of the cone, which are the geometric parameters of a normal Taylor cone. In this case, the diameter and length may be the reference geometric parameters.

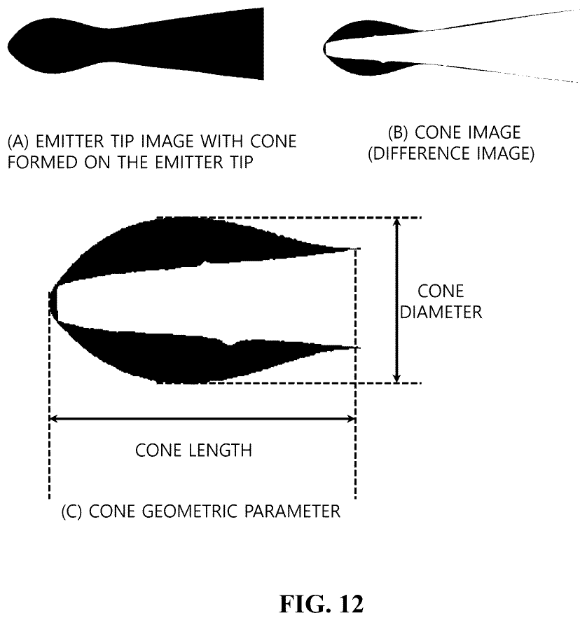

FIG. 12 shows a case in which the diameter and length of the cone are greater than the reference geometric parameters and smaller than a predetermined reference. In this case, when the driving value of the liquid delivery drive unit is maintained and the voltage of the electrode is increased, the state shown in FIG. 11 is achieved.

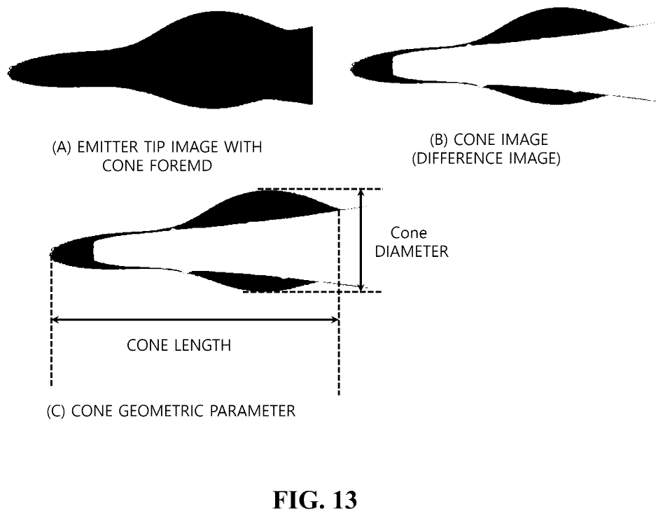

FIG. 13 shows a case in which the diameter and length of the cone are longer than the reference geometric parameters by a predetermined reference or more. In this case, when the driving value of the liquid delivery drive and the voltage of the electrode are both decreased, the state shown in FIG. 11 is achieved.

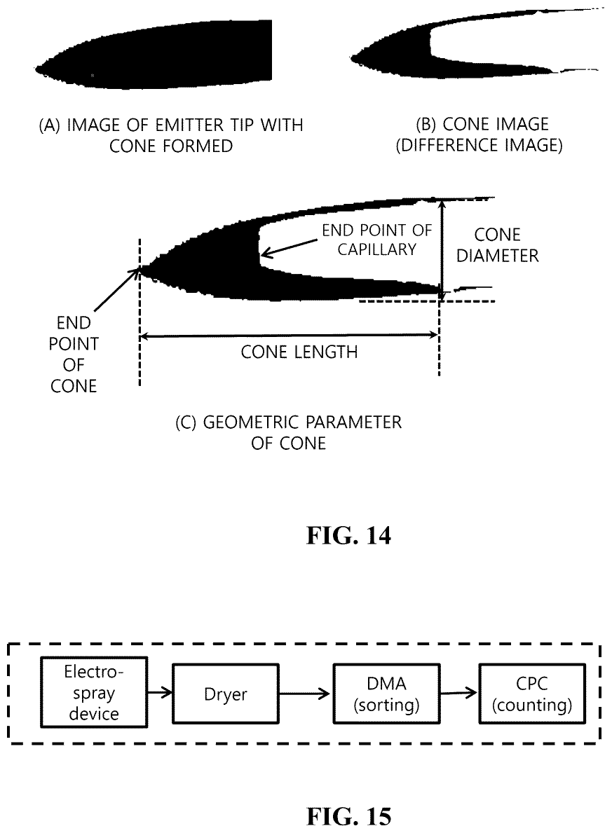

FIG. 14 shows a case in which the diameter of the cone is greater than the reference geometric parameter (reference diameter) and smaller than the predetermined reference, and the length of the cone is greater than the reference geometric parameter (reference length) by a predetermined reference or more. In this case, when the driving value of the liquid delivery drive is maintained and the voltage of the electrode is decreased, the state shown in FIG. 11 is achieved.

Referring to FIGS. 10 to 14, the geometric parameters can be calculated using a difference image obtained by subtracting an initial emitter tip image from the liquid cone image on the emitter tip captured while forming the liquid cone on the emitter tip. The measured geometric parameters and the reference geometric parameters can be compared, and the driving value of the liquid delivery drive unit and the voltage of the electrode part can be controlled based on the difference or ratio between the two parameters. The control can be automatically performed by the control unit.

Additionally, the method of FIGS. 11 to 14 may be combined with the method of FIG. 8. For example, the reference geometric parameters may be included in the recipe, and the control information (the adjustment values of the driving value of the liquid delivery drive unit and the applied voltage) based on the comparison between the measured geometric parameters and the reference geometric parameters may be stored together in the recipe and used to adjust the control parameters. Alternatively, the control information may be stored separately.

The control information may be stored as data in a table format. For example, control information for adjusting control parameters (increasing, maintaining, or decreasing the voltage or flow rate) according to the difference between parameters such as a first measured geometric parameter and a first reference geometric parameter (cone area or diameter) and a second measured geometric parameter and a second reference geometric parameter (cone horizontal length) or the ratio of each measured parameter to the reference parameter may be stored.

Hereinafter, an aerosol-based liquid particle counting system according to an embodiment of the present invention and an example of measurement using the same will be described with reference to FIGS. 15 to 17.

The sample liquid is a solution containing solid fine particles and non-volatile residue (NVR) dissolved therein.

FIG. 15 is a block diagram showing a simplified configuration of an aerosol-based liquid particle counting system including the electrospray device of the present invention. Referring to FIG. 15, after the electrospray device aerosolizes a sample liquid, the droplets are dried by a dryer. Then, the particles are passed through a classifier, such as a differential mobility analyzer (DMA), to classify a particle size, and the particle size distribution is obtained by a condensation particle counter (CPC). Here, the configuration of the dryer, DMA, and CPC is well known in the field of liquid particle counting, and detailed description is omitted.

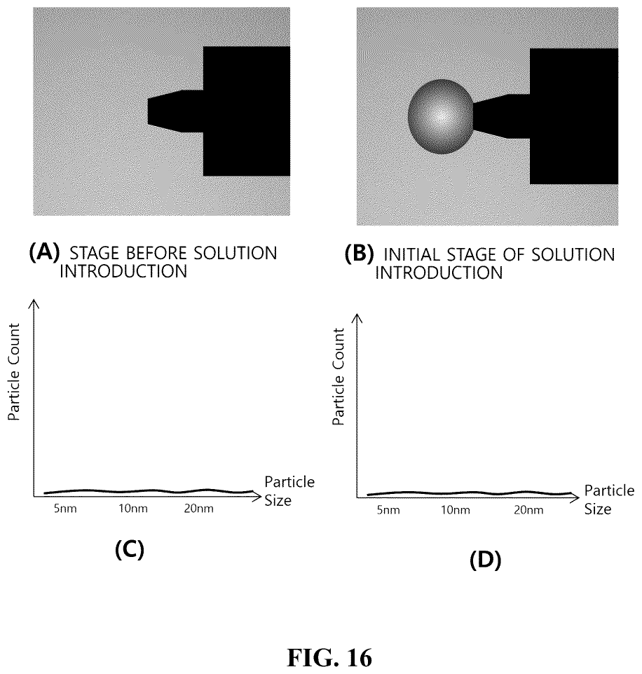

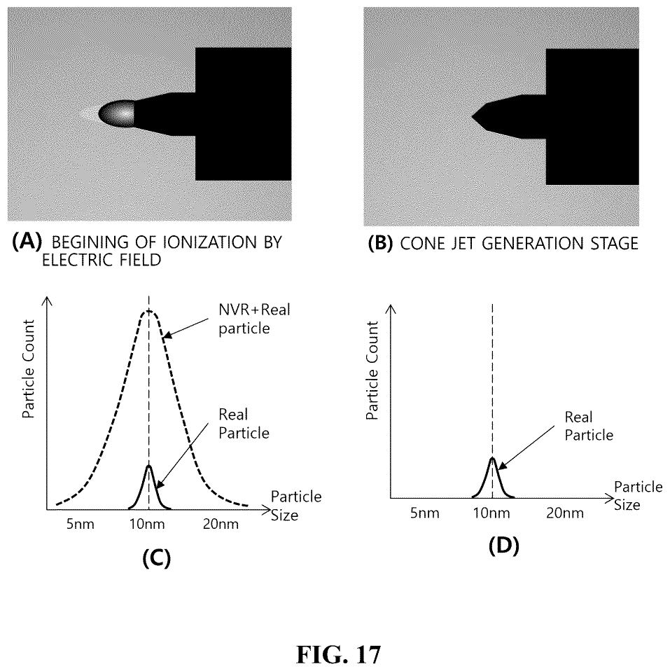

FIGS. 16 and 17 are drawings sequentially showing the results of aerosolizing a sample liquid using an electrospray device according to one embodiment of the present invention, preferably the embodiment shown in FIGS. 3 to 6, and measuring the liquid particle count using an aerosol-based liquid particle counting system.

FIG. 16A shows an image of an emitter tip captured before the sample liquid is introduced into the emitter. FIG. 16C is a graph showing the number of particles (vertical axis) by particle size measured by the particle counting system at that time. In this case, the voltage applied to the electrode part was set to 3.5 kV, and the air pressure provided by the regulator connected to the liquid chamber was 0.

FIG. 16B shows an image of the emitter tip captured at the start stage of introduction of the sample liquid into the emitter. FIG. 16D is a graph showing the number of particles (vertical axis) by particle size measured by the particle counting system at that time. In this case, the voltage applied to the electrode part was set to 3.5 kV, and the air pressure provided by the regulator connected to the liquid chamber was 0.01 MPa. As shown in FIG. 16B, the liquid cone starts to form at the emitter tip.

FIG. 17A shows an image of the emitter tip captured at the state in which ionization acceleration by an electric field starts on the liquid cone on the emitter tip. FIG. 17C is a graph showing the number of particles (vertical axis) by particle size measured by the particle counting system at that time. In this case, the air pressure provided by the regulator connected to the liquid chamber was adjusted to increase up to 0.03 MPa, and the voltage applied to the electrode part was set to 4.0 kV.

FIG. 17B shows an image of the emitter tip captured at the stage where a stable cone jet is generated. FIG. 17D is a graph showing the number of particles (vertical axis) by particle size measured by the particle counting system at that time. In this case, the voltage applied to the electrode part was set to 4.5 kV, and the air pressure provided by the regulator connected to the liquid chamber was 0.05 MPa. Table 1 below shows the control parameters at the stages of FIGS. 16 and 17.

TABLE 1

| | | | 3. Beginning | |
|---|---|---|---|---|
| | 1. Stage | 2. Initial | stage of | |
| | Before | Stage of | Solution | 4. Cone Jet |
| | Solution | Solution | Ionization | Generation |
| Control | Introduction | Introduction | Acceleration | Stage |
| Parameters | Value | | | |
| Sheath Flow | 600 | 600 | 600 | 600 |
| (cc/min) | | | | |
| Voltage (+ kV) | 3.5 | 3.5 | 4.0 | 4.5 |
| Solution | 0 | 0.01 | ~0.03 | 0.05 |
| Pressure | | | | |
| (MPa) | | | | |

In FIGS. 16C and 16D, no significant measurements of particles by size are observed, which is natural since almost no aerosol is generated by the electrospray device at these stages.

FIG. 17C is a graph showing the measurement results obtained at the beginning stage of aerosol generation by the electrospray device, and FIG. 17D is a graph showing the measurement results using the aerosol generated through stable aerosolization.

Referring to FIG. 17C, the measurement results including both the NVR dissolved in the sample solution and the fine particles present in the solid state in the sample liquid are obtained (blue graph). This is because, at the beginning stage of liquid ionization, fine particles are not generated stably and an aerosol composed of relatively large droplets is generated. In this case, issues similar to those in an existing liquid counting system including an atomizer arise. The minimum droplet size generated by an existing atomizer is approximately 250 nm. When these droplets are measured through a dryer-DMA-CPC system, since the original droplet size is relatively large, the distribution of NVR, which crystallizes depending on the droplet size in the dryer, will mix with the fine particle distribution, which interferes with the accurate measurement of the particle count of only fine particles. This problem becomes more critical when measuring fine particles of, 50 nm, particularly 20 nm or less. That is, fine particles of 20 nm or less are dried by the dryer regardless of the droplet size during aerosolization and become pure fine particles. However, when the dissolved NVR undergoes aerosolization, larger droplet sizes result in the formation of larger NVR particles in the drying process. These NVR particles become similar in size to the fine particles after passing through the dryer, leading to measurement results where the distributions of NVR and fine particles are not clearly separated.

This problem is similarly observed in FIG. 17C. In FIG. 17C, the real fine particle distribution is hypothetically shown as a red graph centered around 10 nm. The problem is that in the blue graph showing the measured values, the real fine particle distribution is masked by the NVR distribution. As a result, the two distributions cannot be separated, making it impossible to measure only the desired fine particles. This is because, at the beginning stage of ionization by the electric field, aerosolization is not stable and does not produce droplets of the desired size, resulting in the formation of large droplets.

Referring to FIG. 17B, a cone jet is generated by the generation of a Taylor cone, and an aerosol with a small droplet size of, for example, 50 nm or less, is stably generated. The electrospray device can generate an aerosol composed of droplets of approximately 50 nm through the cone jet created by the Taylor cone. According to one embodiment of the present invention, optimal aerosolization can be achieved by the electrospray device automatically controlling the control parameters based on the liquid cone image on the emitter tip. FIG. 17D shows the measurement results by the aerosol-based liquid particle counting system using the aerosol generated in this way. That is, NVR dissolved in a sample liquid is aerosolized into droplets of 50 nm or less and then dried by a dryer to crystallize into particles smaller than fine particles of 10 nm. Thus, the distribution of fine particles can be separated. Therefore, the distribution of only fine particles can be obtained as shown in FIG. 17D.

According to one aspect of the present invention, an automated electrospray device that automatically and stably generates an aerosol is provided.

According to another aspect of the present invention, an automated electrospray device and an automated aerosol generation method that can stably generate fine droplets even under various liquid and specification conditions are provided.

According to another aspect of the present invention, a liquid particle counting system that can be applied in real time in a production process and has excellent accuracy by eliminating measurement errors caused by NVR is provided.

The technical idea of the present invention is not limited to the above-described embodiments, and for example, the configuration of the discharge path or the specific shape and structure of the discharge valve can be designed and changed in various ways.

1. An electrospray device for aerosolizing a conductive liquid, comprising:
a liquid delivery drive unit by which the conductive liquid is introduced into an emitter;
an emitter that discharges the conductive liquid introduced into the emitter through an emitter tip to aerosolize the conductive liquid;
a counter electrode disposed to face the emitter tip;
a sheath flow guide part disposed around the emitter to provide a sheath flow;
an electrode part that applies a voltage to form a potential difference between the emitter or the conductive liquid and the counter electrode; and
a camera that captures an image of a liquid cone on the emitter tip,
wherein an electric force acts on the conductive liquid on the emitter tip by the voltage applied from the electric electrode part, causing droplets to be discharged from the emitter tip toward the counter electrode to generate an aerosol.

2. The electrospray device of claim 1, wherein control parameters related to aerosol generation are generated based on a shape of the liquid cone on the emitter tip captured by the camera, and
the electrospray device is automatically controlled using the control parameters.

3. The electrospray device of claim 2, wherein the control parameters include at least one of the voltage and a flow rate of the conductive liquid supplied to the emitter.

4. The electrospray device of claim 1, wherein a lighting unit is disposed at a position facing the camera with the emitter tip interposed therebetween, and
aerosolization is controlled based on the shape of the liquid cone on the emitter tip captured by the camera.

5. The electrospray device of claim 1, further comprising:
a liquid supply tube connected to one side of a chamber housing to supply the conductive liquid to the emitter; and
a flowmeter that measures a flow rate of the conductive liquid supplied through the liquid supply tube,
wherein the liquid delivery drive unit is a regulator that controls the flow rate of the conductive liquid using a measurement value measured by the flowmeter.

6. The electrospray device of claim 1, further comprising a control unit that generates the control parameters for generating an aerosol and automatically controls the electrospray device,
wherein the control unit is included in the electrospray device or is an external information processing device connected to the electrospray device by communication, and
wherein the control unit processes a liquid cone image of the liquid cone on the emitter tip captured by the camera, compares the liquid cone image with a reference image, and adjusts the control parameters according to a comparison result.

7. An electrospray device comprising:
a liquid chamber that accommodates a sample liquid having electrical conductivity;
an aerosolization chamber connected to the liquid chamber to receive the sample liquid from the liquid chamber and aerosolize the sample liquid; and
a liquid delivery drive unit that moves the sample liquid in the liquid chamber to the aerosolization chamber,
wherein the aerosolization chamber comprises:
an emitter that discharges the sample liquid introduced from the liquid chamber through an emitter tip and aerosolizes the sample liquid;
a counter electrode disposed to face the emitter tip;
a sheath flow guide part disposed around the emitter to provide a sheath flow;
a power supply that applies a voltage to form a potential difference between the emitter or the sample liquid and the counter electrode; and
a camera that captures an image of a liquid cone on the emitter tip, and
wherein an electric force acts on the liquid cone on the emitter tip by the applied voltage, causing droplets to be discharged from the emitter tip toward the counter electrode to generate an aerosol.

8. The electrospray device of claim 7, further comprising:
a differential gauge that measures a pressure difference between the liquid chamber and the aerosolization chamber; and
a control unit connected to the power supply, the differential gauge, the camera, and the liquid delivery drive unit,
wherein the control unit generates control parameters for automatically adjusting the voltage and the pressure difference based on an image of the liquid cone on the emitter chip captured by the camera.

9. The electrospray device of claim 8, wherein the liquid delivery drive unit is a differential regulator connected to the liquid chamber to generate a pressure difference between the liquid chamber and the aerosolization chamber; and
the differential regulator and the power supply are automatically controlled using control parameters.

10. An aerosol-based liquid particle counting system comprising:
the electrospray device of claim 1;
a dryer that dries the aerosol discharged from the electrospray device;
a particle classification device connected to the dryer; and
a condensation particle counter connected to the particle classification device.

11. An automated control method of the electrospray device of claim 1, the method comprising:
obtaining a liquid cone image by operating the electrospray device to generate a liquid cone on the emitter tip and capturing an image of the liquid cone on the emitter tip in real time;
processing the liquid cone image; and
adjusting control parameters.

12. The automated control method of claim 11, further comprising generating a recipe before the obtaining of the liquid cone image,
wherein the recipe includes a reference image or reference geometric parameters according to a type of the conductive liquid.

13. The automated control method of claim 12, wherein, before the adjusting of the parameters, the liquid cone image is compared with the reference image in the recipe to determine whether to adjust the control parameters, and
the reference image is an image of the liquid cone on the emitter tip captured when optimal aerosolization is achieved.

14. The automated control method of claim 11, further comprising, before the obtaining of the liquid cone image, generating a recipe, wherein the recipe includes a reference image and a reference cone horizontal length, the reference image is an image of the liquid cone on the emitter tip captured when optimal aerosolization is achieved, and the reference cone horizontal length is a horizontal length of only the cone on the emitter tip in the reference image,
wherein the processing of the liquid cone image comprises:
obtaining a difference image between the liquid cone image and the reference image;
calculating a difference in the cone horizontal length between the liquid cone image and the reference image;
calculating an area of the difference image;
determining whether both the area of the difference image and the length difference are within allowable values; and
maintaining the control parameters when the area and the difference are within the allowable values according to the determination, and adjusting the control parameters when the area and the difference are outside the allowable values,
wherein the difference in the cone horizontal length is a difference between the reference cone horizontal length and the cone horizontal length in the liquid cone image.

15. The automated control method of claim 11, further comprising:
before the obtaining of the liquid cone image while generating the liquid cone,
capturing an initial emitter image including the emitter tip in a state in which the liquid cone is not generated; and
calculating parameters from the initial emitter image and storing the reference parameters,
wherein the processing of the liquid cone image comprises:
performing preprocessing on the liquid cone image;
obtaining a cone image by subtracting the initial emitter image from the liquid cone image;
processing the cone image to calculate one or more geometric parameters;
comparing the geometric parameters with the reference parameters;
generating control parameters based on the comparison; and
adjusting at least one of the voltage, a flow rate of a supply tube, and a driving value of the liquid delivery drive unit based on the control parameters.
